(19) United States
(12) Patent Application Publication
(10) Pub. No.: US 2026/0038074 A1
(43) Pub. Date: Feb. 5, 2026

(54) STORED-VALUE CARD SECURITY FOR FIXTURES

(71) Applicant: Blackhawk Network, Inc., Pleasanton, CA (US)

(72) Inventors: Michael Carrow, Walnut Creek, CA (US); Jack Hu, Pleasanton, CA (US)

(73) Assignee: Blackhawk Network, Inc., Pleasanton, CA (US)

(21) Appl. No.: 19/352,369

(22) Filed: Oct. 7, 2025

Related U.S. Application Data
(63) Continuation of application No. PCT/US2024/043769, filed on Aug. 23, 2024.
(60) Provisional application No. 63/534,647, filed on Aug. 25, 2023.
(60) Provisional application No. 63/535,559, filed on Aug. 30, 2023.
(60) Provisional application No. 63/536,092, filed on Sep. 1, 2023.
(60) Provisional application No. 63/678,698, filed on Aug. 2, 2024.
(60) Provisional application No. 63/704,896, filed on Oct. 8, 2024.

(51) Int. Cl. G06Q 90/00

(52) U.S. Cl. CPC G06Q 90/00

(57) ABSTRACT

A security enhanced display apparatus includes a body configured to position against a display and retain a plurality of stored-value cards. A display component extends from the body and is configured to attach to the display so that the display apparatus is locked to the display. A fraud deterrent component extends from the body and is configured to impede, and in some embodiments prevent, stored-value cards that have been removed from the body from being repositioned on the body.

### CROSS REFERENCE TO RELATED APPLICATIONS

This application claims priority to U.S. Patent Application No. 63/704,896 filed Oct. 8, 2024 and this application is a continuation of and claims priority to PCT Patent Application No. PCT/US2024/043769 filed Aug. 23, 2024, which claims priority to U.S. Patent Application No. 63/534,647 filed Aug. 25, 2023, U.S. Patent Application No. 63/535,559 filed Aug. 30, 2023, U.S. Patent Application No. 63/536,092 filed Sep. 1, 2023, and U.S. Patent Application No. 63/678,698 filed Aug. 2, 2024, all of which are incorporated herein by reference in their entireties.

### BACKGROUND

The present disclosure relates to a peg board display apparatus and, in particular, to a security enhanced peg board display apparatus.

Often, stored-value cards are displayed at retailers on peg boards having stored-value card hooks. Generally, the stored-value card hooks do not include security features to prevent tampering with the stored-value cards. That is, stored-value card hooks generally enable a customer to remove more than one stored-value card from the hook at a time. Additionally, a fraudster is commonly capable of removing cards, tampering with the removed cards, and then returning multiple cards to the hook at once. A need remains for security features stored-value card fixtures.

### SUMMARY

The present disclosure includes one or more of the features recited in the appended claims and/or the following features which, alone or in any combination, may comprise patentable subject matter.

According to a first aspect of the disclosed embodiments, a security enhanced peg board display apparatus includes a body configured to position against a peg board display. The body has a back side and an opposite front side. The back side and the front side extend between a top and a bottom. A peg board display component extends from the back side of the body and is configured to attach to the peg board display so that the display apparatus is locked to the peg board display. A card retention device is included on the body and is configured to retain a plurality of stored-value cards. A one-way gate impedes, and in some embodiments prevents, the repositioning of stored-value cards that have been removed from the card retention device back onto or into the card retention device.

In some embodiments of the first aspect, the card retention device may allow a single stored-value card to be removed from the card retention device at one time. The card retention device may include a fraud deterrent mechanism that impedes the stored-value cards that have been removed from the card retention device from being repositioned on the card retention device. A tool may be configured to unlock the peg board display component from the peg board display. The peg board display component may be unlocked from the peg board display to stock the card retention device with the plurality of stored-value cards. The card retention device may be stocked with the plurality of stored-value cards without unlocking the peg board display component from the peg board display. A tool may be configured to allow access the card retention device to position the plurality of stored-value cards on the card retention device. The peg board display component may include a top peg board display component extending from the top of the body and a bottom peg board display component extending from the bottom of the body.

According to a second aspect of the disclosed embodiments, a security enhanced peg board display apparatus includes a body configured to position against a peg board display. The body has a back side and an opposite front side. The back side and the front side extend between a top and a bottom. At least one peg board hook extends from the back side of the body and is configured to be inserted in a hole in the peg board display so that the display apparatus cannot be removed from the peg board display by hand. A fraud deterrent component extends from the front side of the body and is configured to retain a plurality of stored-value cards. The fraud deterrent component includes a one-way gate having an upper arm and a lower arm. The plurality of stored-value cards are retained on the lower arm. At least one of the upper arm and the lower arm incudes a flange that impedes, and in some embodiments prevents, stored-value cards that have been removed from the lower arm from being repositioned on the lower arm.

Optionally, in the second aspect, the flange may allow a single stored-value card to be removed from the lower arm at one time. The flange may include a fraud deterrent mechanism that impedes the stored-value cards that have been removed from the lower arm from being repositioned on the lower arm. A tool may be configured to remove the peg board hook from the peg board display. The peg board hook may be unlocked from the peg board display to stock the lower arm with the plurality of stored-value cards. The lower arm may be stocked with the plurality of stored-value cards without unlocking the peg board hook from the peg board display. The upper arm may be movable to access the lower arm and position the plurality of stored-value cards on the lower arm. A tool may be configured to move the upper arm. The peg board hook may include a top peg board hook extending from the top of the body and a bottom peg board hook extending from the bottom of the body.

According to a third aspect of the disclosed embodiments, a security enhanced peg board display apparatus includes a body configured to position against a peg board display and retain a plurality of stored-value cards. A peg board display component extends from the body and is configured to attach to the peg board display so that the display apparatus is locked to the peg board display. A fraud deterrent component extends from the body and is configured to impede, and in some embodiments prevent, stored-value cards that have been removed from the body from being repositioned on the body.

It may be desired, in the third aspect, that a tool is configured to allow the plurality of stored-value cards to be positioned on the body. The fraud deterrent component may allow a single stored-value card to be removed from the body at one time.

According to a fourth aspect of the disclosed embodiments, a security enhanced display apparatus includes a body configured to position against a display. The body has a back side and an opposite front side. The back side and the front side extend between a top and a bottom. A display component extends from the back side of the body and is configured to attach to the display so that the display apparatus is locked to the display. A card retention device is included on the body and is configured to retain a plurality of stored-value cards. A one-way gate impedes, and in some embodiments prevents, the repositioning of stored-value cards that have been removed from the card retention device back onto or into the card retention device.

In some embodiments of the fourth aspect, the card retention device may allow a single stored-value card to be removed from the card retention device at one time. The card retention device may include a fraud deterrent mechanism that impedes the stored-value cards that have been removed from the card retention device from being repositioned on the card retention device. A tool may be configured to unlock the display component from the display. The display component may be unlocked from the display to stock the card retention device with the plurality of stored-value cards. The card retention device may be stocked with the plurality of stored-value cards without unlocking the display component from the display. A tool may be configured to allow access the card retention device to position the plurality of stored-value cards on the card retention device. The display component may include a top display component extending from the top of the body and a bottom display component extending from the bottom of the body.

According to a fifth aspect of the disclosed embodiments, a security enhanced display apparatus includes a body configured to position against a display. The body has a back side and an opposite front side. The back side and the front side extend between a top and a bottom. At least one fastener extends from the back side of the body and is configured to be coupled to the display so that the display apparatus cannot be removed from the display by hand. A fraud deterrent component extends from the front side of the body and is configured to retain a plurality of stored-value cards. The fraud deterrent component includes a one-way gate having an upper arm and a lower arm. The plurality of stored-value cards are retained on the lower arm. At least one of the upper arm and the lower arm incudes a flange that impedes, and in some embodiments prevents, stored-value cards that have been removed from the lower arm from being repositioned on the lower arm.

Optionally, in the fifth aspect, the flange may allow a single stored-value card to be removed from the lower arm at one time. The flange may include a fraud deterrent mechanism that impedes the stored-value cards that have been removed from the lower arm from being repositioned on the lower arm. A tool may be configured to remove the fastener from the display. The fastener may be unlocked from the display to stock the lower arm with the plurality of stored-value cards. The lower arm may be stocked with the plurality of stored-value cards without unlocking the fastener from the display. The upper arm may be movable to access the lower arm and position the plurality of stored-value cards on the lower arm. A tool may be configured to move the upper arm. The fastener may include a top fastener extending from the top of the body and a bottom fastener extending from the bottom of the body.

According to a sixth aspect of the disclosed embodiments, a security enhanced display apparatus includes a body configured to position against a display and retain a plurality of stored-value cards. A display component extends from the body and is configured to attach to the display so that the display apparatus is locked to the display. A fraud deterrent component extends from the body and is configured to impede, and in some embodiments prevent, stored-value cards that have been removed from the body from being repositioned on the body.

It may be desired, in the sixth aspect, that a tool is configured to allow the plurality of stored-value cards to be positioned on the body. The fraud deterrent component may allow a single stored-value card to be removed from the body at one time.

Additional features, which alone or in combination with any other feature(s), such as those listed above and/or those listed in the claims, can comprise patentable subject matter and will become apparent to those skilled in the art upon consideration of the following detailed description of various embodiments exemplifying the best mode of carrying out the embodiments as presently perceived.

### BRIEF DESCRIPTION

The detailed description particularly refers to the accompanying figures in which:

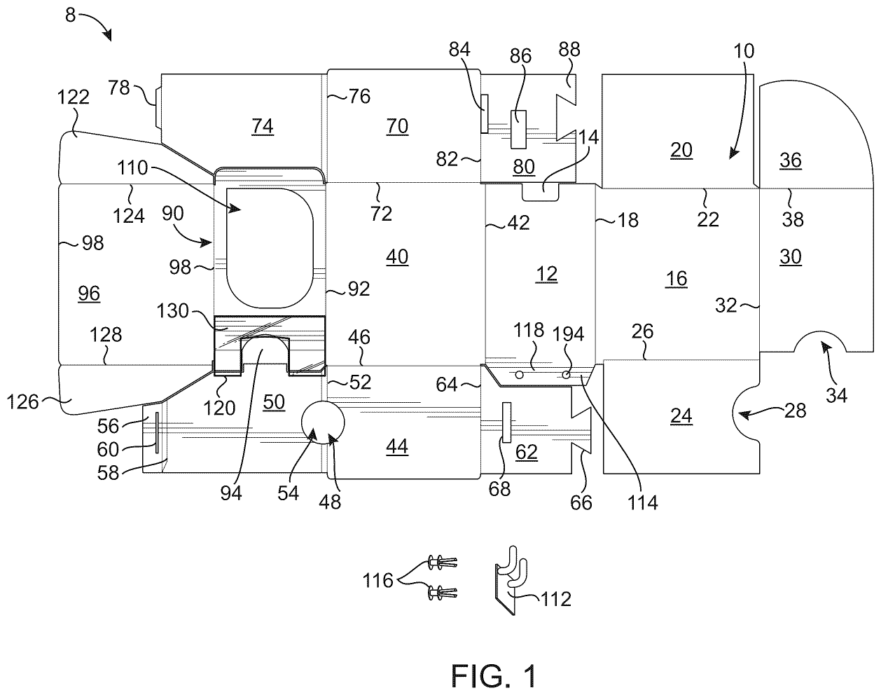

FIG. 1 is an exploded view of an assembly including a blank for building a security box, a hook for hanging the security box on a peg board, and a pair of pegs for securing the security box to the peg board;

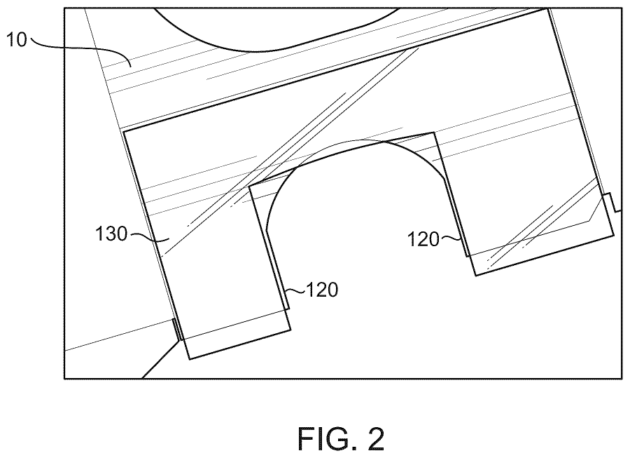

FIG. 2 is an expanded view of a security flap of the security box;

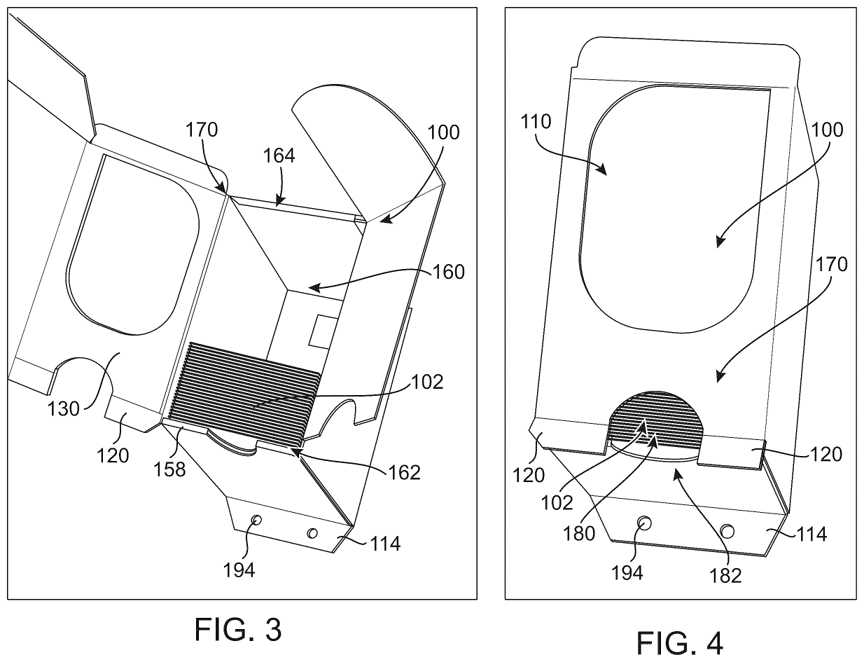

FIG. 3 is a front perspective view of the security box in an open configuration for positioning stored-value cards in a cavity of the security box;

FIG. 4 is a front perspective view of the security box in a closed position for use in a retail location;

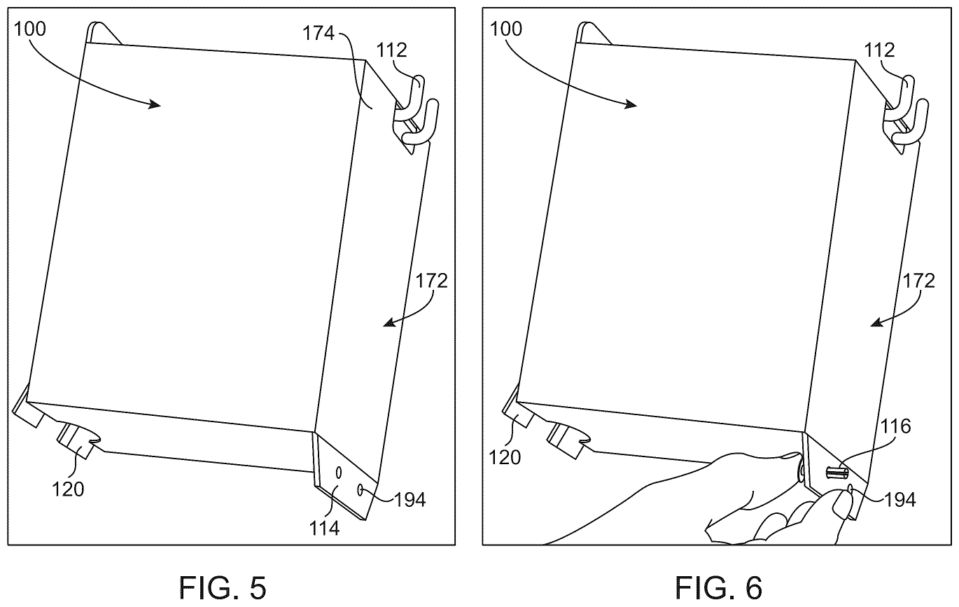

FIG. 5 is a back perspective view of the security box illustrating the hook extending from a top of the security box;

FIG. 6 is a back perspective view of the security box illustrating a peg extended through a flap extending from a bottom of the security box;

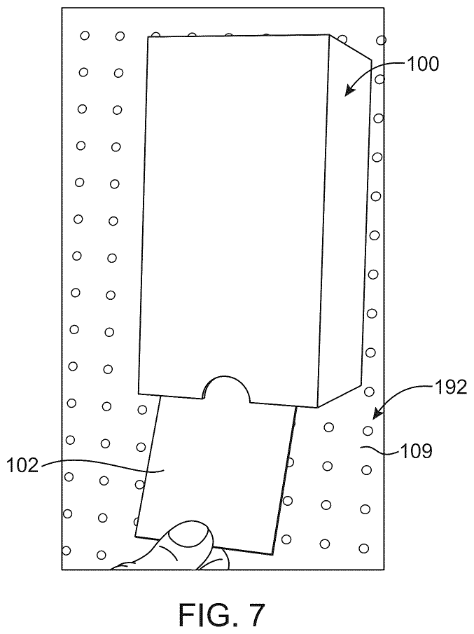

FIG. 7 is a front perspective view of a stored-value card being removed from the security box;

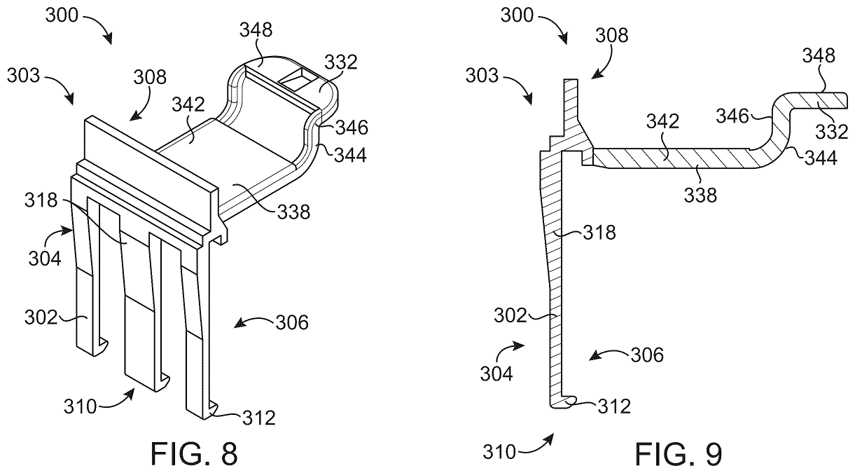

FIG. 8 is a top perspective view of a security hook in accordance with an embodiment:

FIG. 9 is a side cross-sectional view of the security hook shown in FIG. 8;

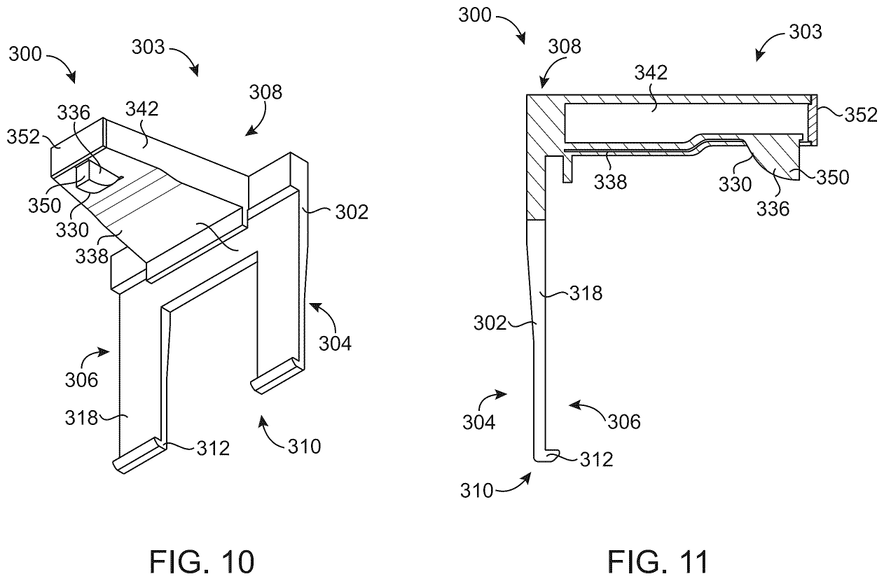

FIG. 10 is a bottom perspective view of a security hook in accordance with another embodiment;

FIG. 11 is a side cross-sectional view of the security hook shown in FIG. 10;

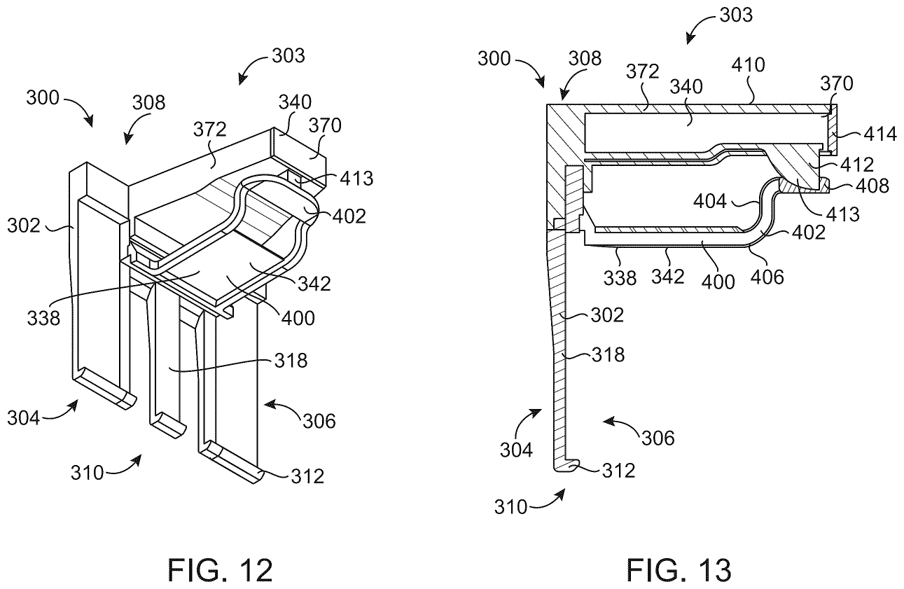

FIG. 12 is a bottom perspective view of a security hook in accordance with yet another embodiment;

FIG. 13 is a side cross-sectional view of the security hook shown in FIG. 12;

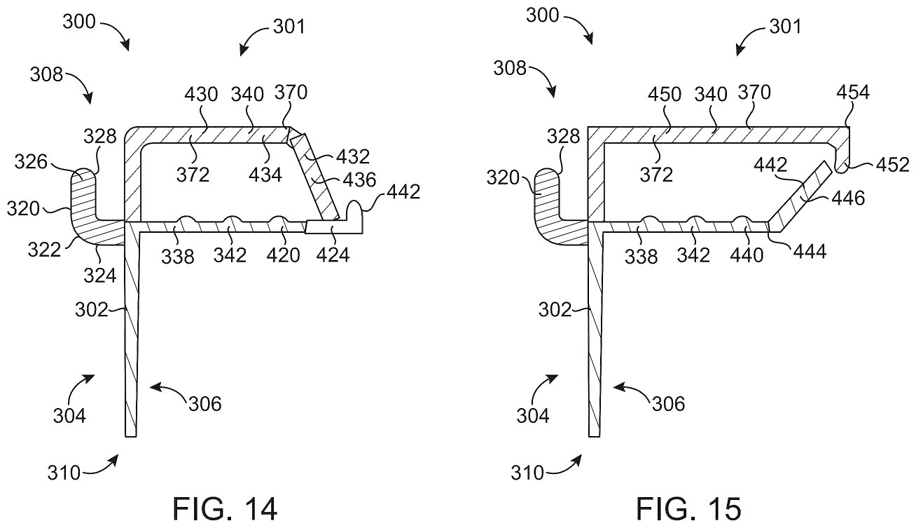

FIG. 14 is a cross-sectional view of a security hook in accordance with a further embodiment;

FIG. 15 is a cross-sectional view of a variation of the security hook shown in FIG. 14;

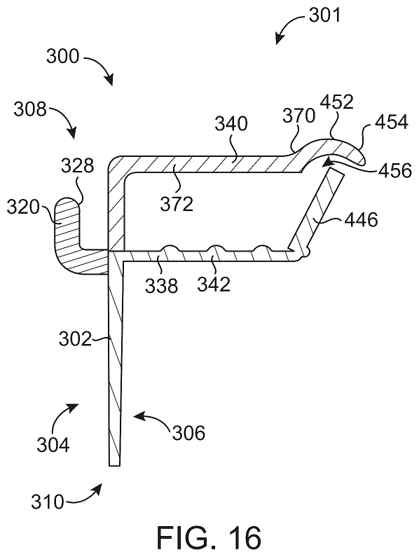

FIG. 16 is a cross-sectional view of another variation of the security hook shown in FIG. 14;

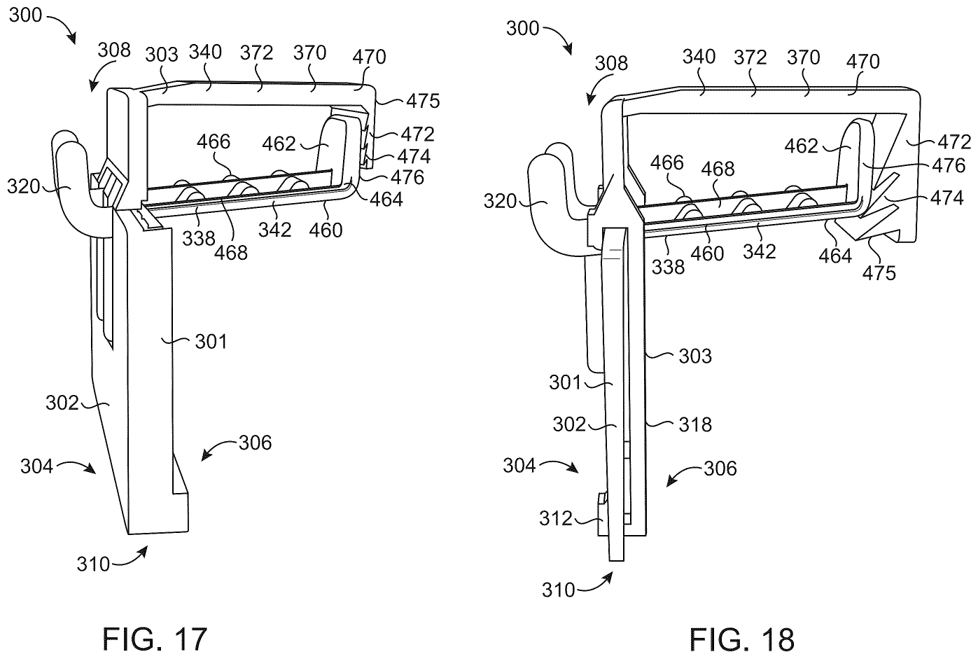

FIG. 17 is a side perspective view of a security hook in accordance with an additional embodiment;

FIG. 18 is a side perspective view of a variation of the security hook shown in FIG. 17;

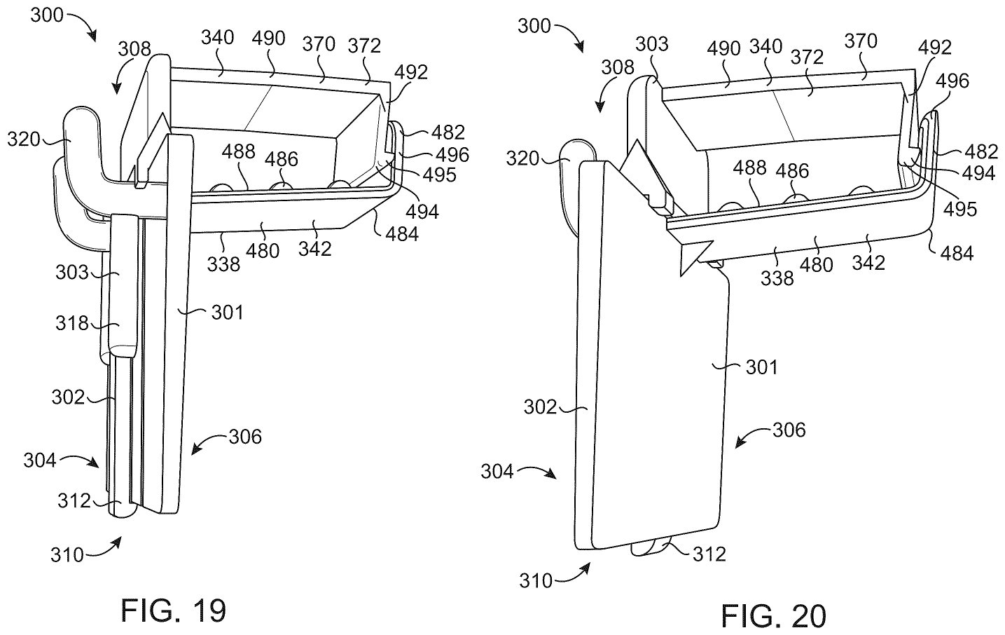

FIG. 19 is a side perspective view of a security hook in accordance with another embodiment;

FIG. 20 is a side perspective view of a variation of the security book shown in FIG. 19;

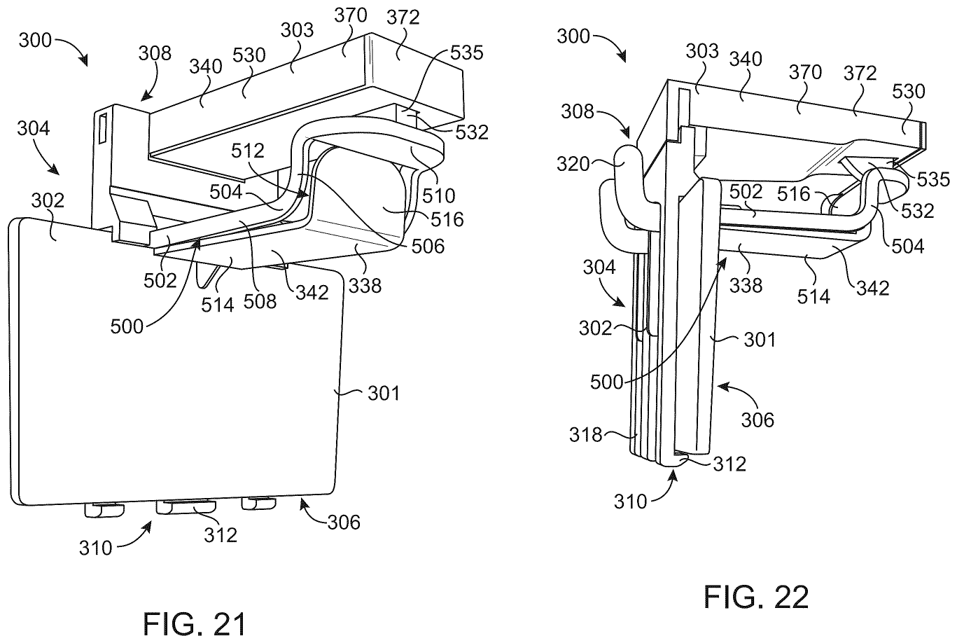

FIG. 21 is a side perspective view of a security hook in accordance with yet another embodiment;

FIG. 22 is a side perspective view of a variation of the security hook shown in FIG. 21;

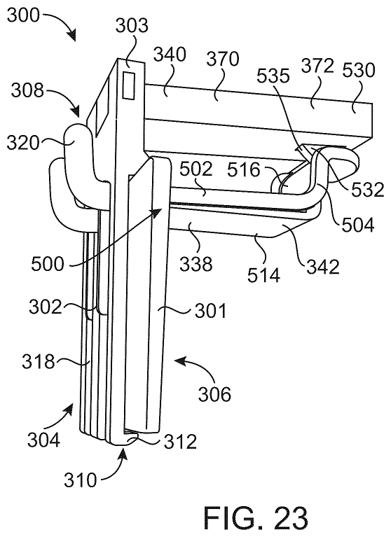

FIG. 23 is a side perspective view of another variation of the security hook shown in FIG. 21;

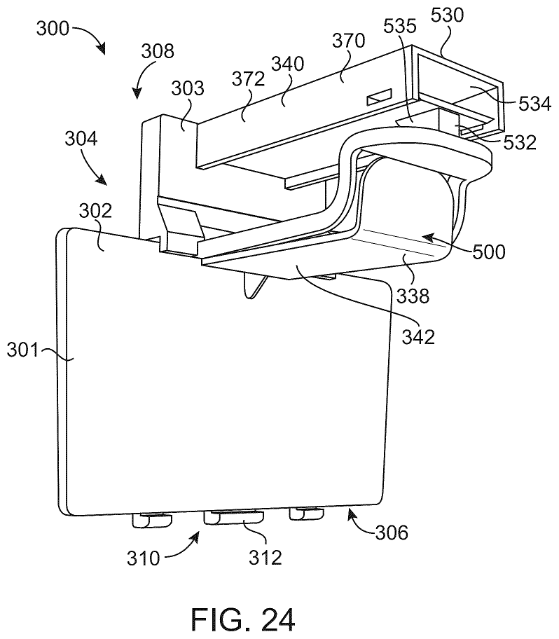

FIG. 24 is a side perspective view of a security hook in accordance with a further embodiment;

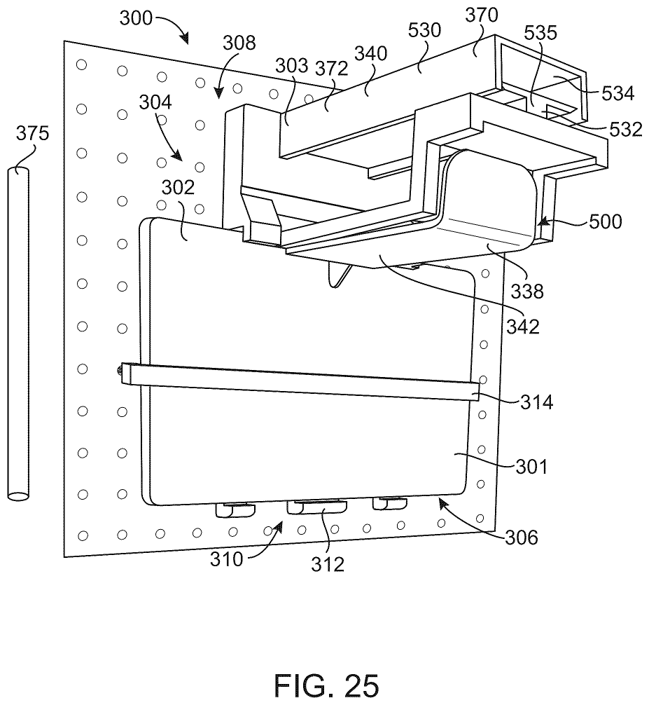

FIG. 25 is a side perspective view of a variation of the security hook shown in FIG. 24;

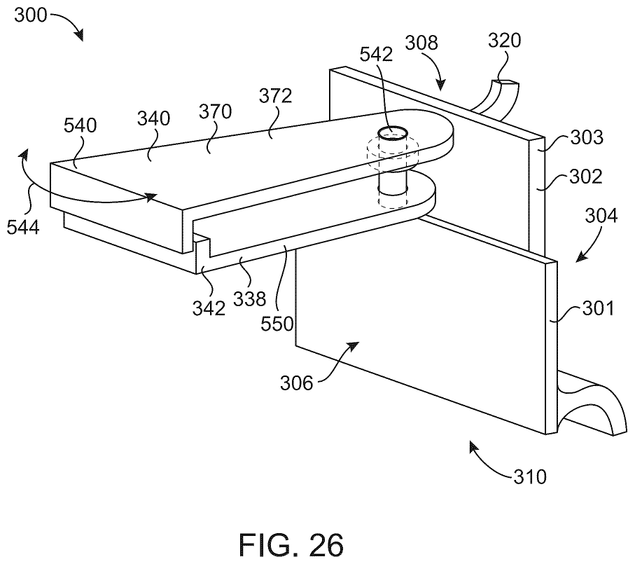

FIG. 26 is a side perspective view of a security hook in accordance with an additional embodiment;

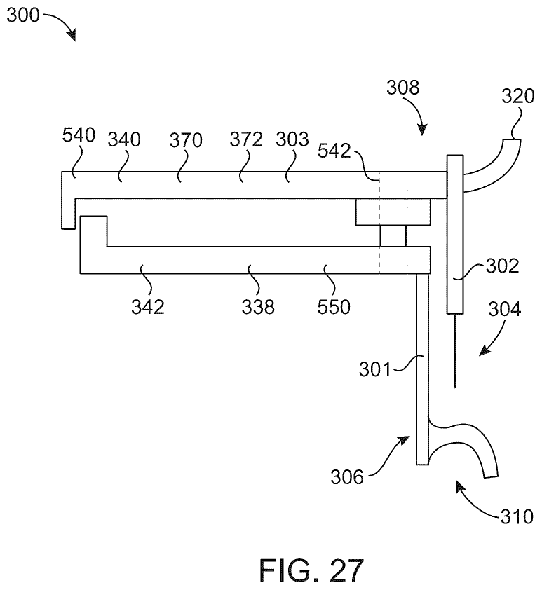

FIG. 27 is a side perspective view of a variation of the security hook shown in FIG. 26;

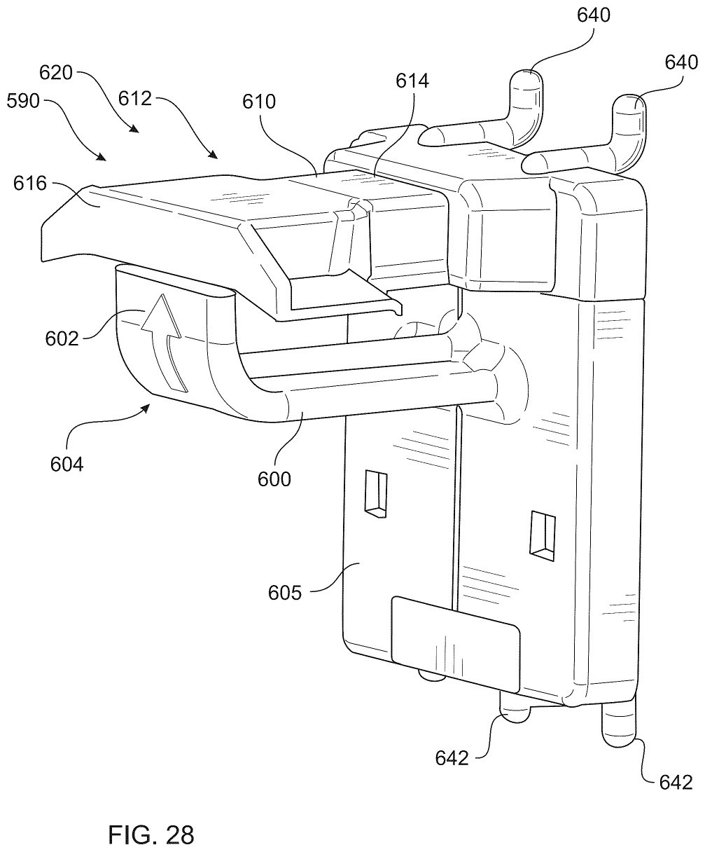

FIG. 28 is a side perspective view of a security hook in accordance with another embodiment and shown in a closed configuration;

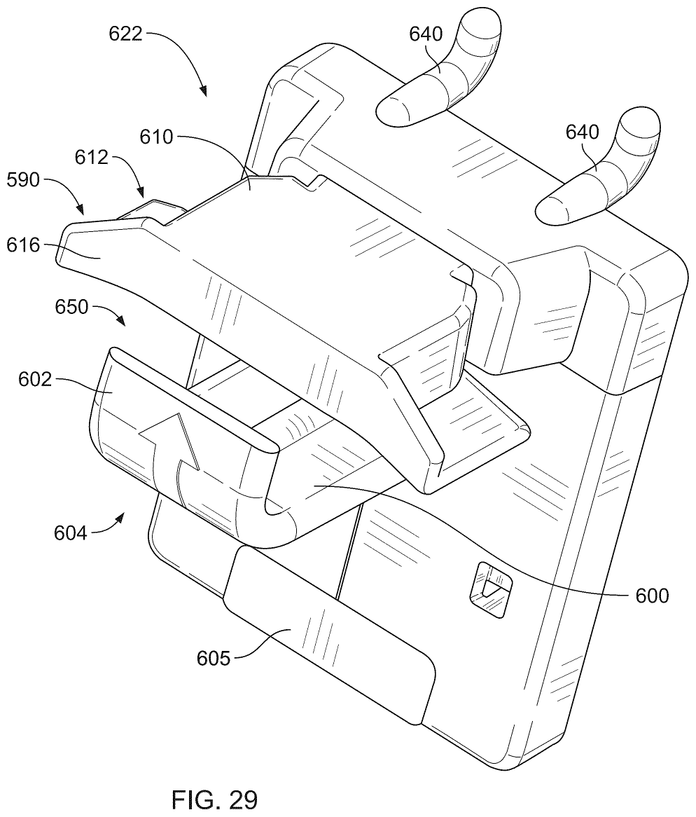

FIG. 29 is a side perspective view of the security hook shown in FIG. 28 and in an open configuration;

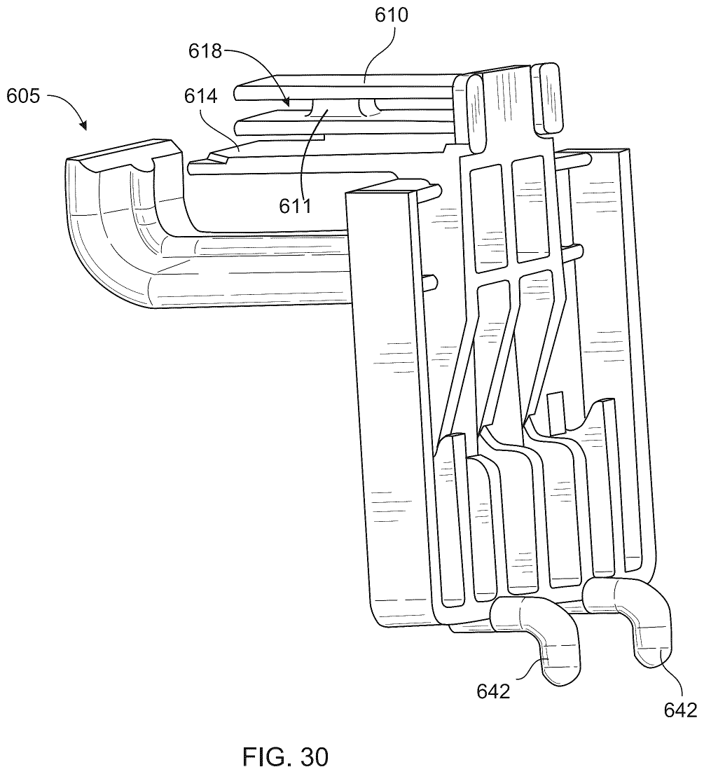

FIG. 30 is a side perspective view of a base of the security hook shown in FIG. 28;

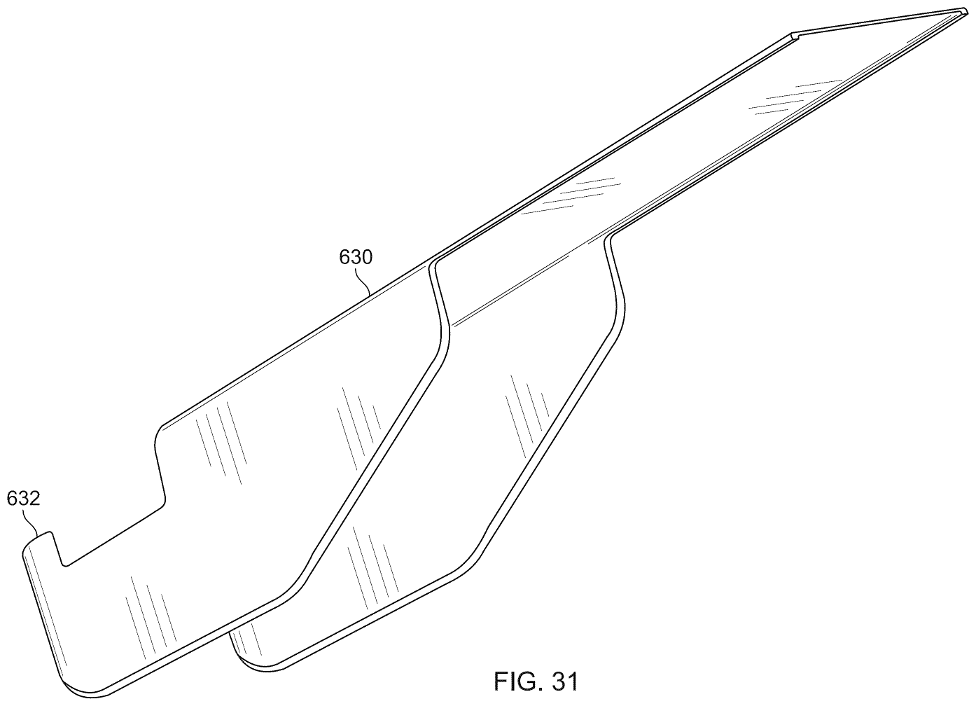

FIG. 31 is a side perspective of a tool used to move the security hook shown in FIG. 28 from the closed position to the open position shown in FIG. 29;

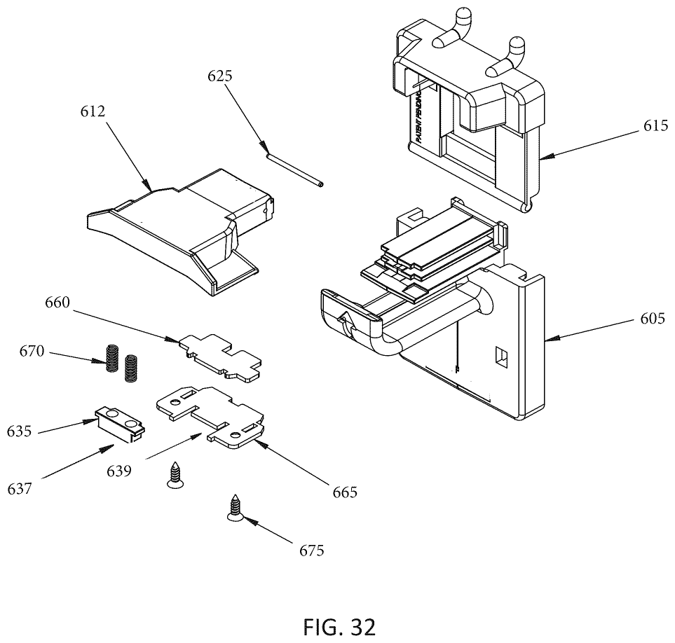

FIG. 32 is an exploded view of the security hook shown in FIG. 28;

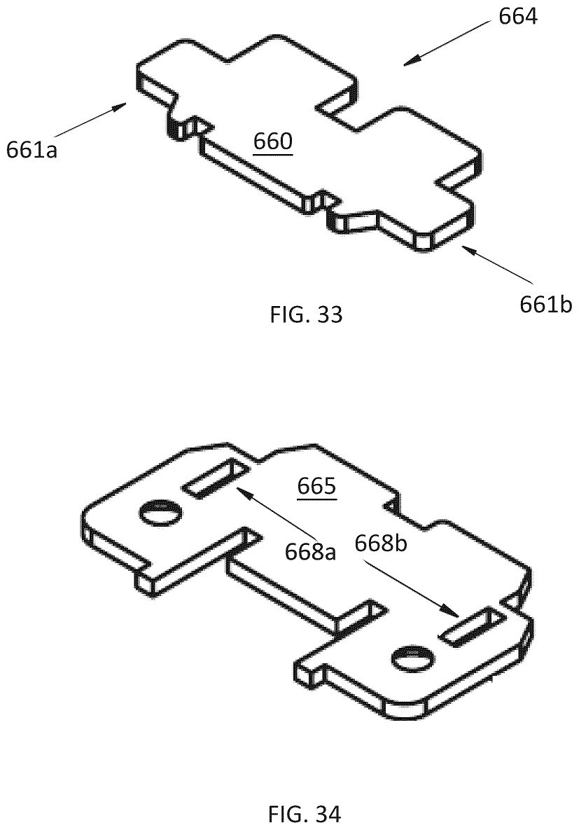

FIG. 33 is top perspective view of a lock plate as shown in FIG. 32; and

FIG. 34 is a top perspective view of a lock cover as shown in FIG. 32.

### DETAILED DESCRIPTION

For the purposes of promoting an understanding of the principles of the disclosure, reference will now be made to a number of illustrative embodiments illustrated in the drawings and specific language will be used to describe the same.

The embodiments described and shown herein provide apparatus for reducing, dissuading, and preventing fraud. In particular, the fraud-deterring display and dispensing apparatus disclosed herein include a box (as shown in FIGS. 1-7) and a hook (as shown in FIGS. 8-30) having a dispensing system that hinders, impedes, hampers, restrains, restricts, and prevents an unactivated stored-value card (e.g., a gift card or a debit card) from being removed and then positioned back on the hook or back in the box. For ease of reference, throughout this application stored-value cards will be referred to as stored-value cards, SVCs, gift cards, and debit cards. Moreover, the theories and functionalities underlying the apparatus for displaying and dispensing stored-value cards are equally applicable to other commercial products capable of being similarly displayed and dispensed. Accordingly, fraudsters can be prevented from stealing and/or tampering with stored-value card account information such as redemption information, activation information, and authorization information on the stored-value card or stored-value card packaging. It will be appreciated that the apparatus described and shown herein are configured to retain a plurality of stored-value cards that are configured to be individually removed from the apparatus. As set forth above, in an embodiment, once an individual card is removed from the apparatus, a consumer's, would-be purchaser's, or fraudster's attempt to position the stored-value card back in or on the apparatus is hindered, impeded, hampered, or otherwise challenged. In an embodiment, once an individual card is removed from the apparatus, a consumer's, would-be purchaser's, or fraudster's attempt to position the stored-value card back in or on the apparatus is prevented. In certain embodiments, a stored-value card which is removed from a fraud-deterring display and dispensing apparatus as described herein can only be reinserted or repositioned in or on the fraud-deterring display and dispensing apparatus via the use of a tool, key, or authorization code, said tool, key, or authorization code being in the possession and control of an authorized merchant, retailer, wholesaler, or other authorized distributor of stored-value cards (or agents, employees, and contractors of the authorized merchants, retailers, wholesalers, and other authorized distributors of stored-value cards).

In some embodiments, the apparatus includes velocity controls that lock or pause disbursement of the cards. In some embodiments, the apparatus includes tamper deterrents such as alarms. In some embodiments, the apparatus includes a video link or security camera built in. In some embodiments, the apparatus includes a modular design where individual box dispensers connect via a matrix. In some embodiments, the apparatus includes a video display or digital display with a quick-response (QR) code or barcode that launches an endless endcap store. In some embodiments, the apparatus includes a physical QR code or scannable code. In some embodiments, the apparatus includes a protected corrugated enclosure that is pre-packed with cards and fixes to stored-value card displays. In some embodiments, the apparatus includes an injection molded enclosure. In some embodiments the apparatus includes a clear polyethylene terephthalate glycol (PETG) or metal housing with a clear window.

Referring now to FIG. 1, an assembly 8 including a blank 10 formed from cardboard, plastic, or the like and configured to be folded into the box 100, shown in FIGS. 3-7. The box 100 is configured for preventing fraud and storing a plurality of stored-value cards 102. The assembly 10 also includes a hook 112 and pegs 116. Notably, the box 100 includes a security flap 130 (shown in more detail in FIG. 2) positioned on flanges 120. The security flap 130 is positioned in an opening 180 (shown in more detail in FIG. 4) of the assembled box 100 so that only a single stored-value card 102 can position in the opening of the assembled box 100. The single stored-value card 102 is accessible through the opening 180 to be removed; however, once the stored-value card 102 is removed another stored-value card 102 takes its place and the security flap 130 hinders repositioning of the removed stored-value card 102 into the assembled box 100. In an embodiment, the security flap 130 prevents repositioning of the removed stored-value card 102 into the assembled box 100

The blank 10 includes a back panel 12 having a notch 14. A flap 114 extends from the back panel 12 along a fold line 118. The flap 114 includes a pair of holes 194 extending therethrough. An inner side panel 16 extends from the back panel 12 along a fold line 18. An inner top panel 20 extends from the inner side panel 16 along a fold line 22, and an inner bottom panel 24 extends from the inner side panel 16 along a fold line 26. The inner bottom panel 24 includes a notch 28. An inner front panel 30 extends from the inner side panel 16 along a fold line 32. The inner front panel 30 includes a notch 34. A flap 36 extends from the inner front panel 30 along a fold line 38.

An outer side panel 40 extends from the back panel 12 along a fold line 42. An outer bottom panel 44 extends from the outer side panel 40 along a fold line 46. The outer bottom panel 44 includes a notch 48. A flap 50 extends from the outer bottom panel 44 along a fold line 52 and includes a notch 54 aligned with the notch 48. A tab 56 extends from the flap 50 along a fold line 58. A slot 60 is formed in the tab 56. Another flap 62 extends from the outer bottom panel 44 along a fold line 64. The flap 62 includes a tab 66 and a slot 68.

An outer top panel 70 extends from the outer side panel 40 along a fold line 72. A flap 74 extends from the outer top panel 70 along a fold line 76 and includes a tab 78. A flap 80 extends from the outer top panel 70 along a fold line 82. The flap 80 includes a slot 84, a slot 86, and a notch 88.

An outer front panel 90 extends from the outer side panel 40 along a fold line 92. The outer front panel 90 includes a widow 110 and a notch 94. A pair of flanges 120 extend from the outer front panel 90 adjacent the notch 94. A security flap 130 is positioned around the notch 94 and along the flanges 120. The flanges 120 and the security flap 130 are shown in more detail in FIG. 2. An outer side panel 96 extends from the outer front panel 90 along a fold line 98. A top flap 122 extends from the outer side panel 96 along a fold line 124, and a bottom flap 126 extends from the outer side panel 96 along a fold line 128.

The blank 10 is configured to be folded along the various fold lines to form the box 100 shown in FIG. 3. The outer front panel 90 is folded to form a front 170 of the box 100 so that the window 110 is viewed from the front 170 of the box 100. The inner front panel 30 positions behind the outer front panel 90 so that a sample stored-value card can be positioned between the inner front panel 30 and the outer front panel 90 and is visible through the window 110. The notches 28, 34, 48, 54, and 94 each align to form an opening 180 in a bottom 182 of the front 170 of the box 100. The back panel 12 forms a back 172 of the box 100. The various other tabs and notches couple together secure the box 100 in the configuration shown in FIGS. 3-7.

The box 100 includes card retention device 158 having stored-value cards 102 positioned thereon. In the exemplary embodiment, the card retention device 158 includes a bottom surface 162 of a cavity 160 formed by the box 100. It will be appreciated that the entire box 100 can be filled with stored-value cards 102 from the bottom surface 162 of the cavity 160 to a top surface 164 of the cavity 160. FIG. 4 illustrates the box 100 in a closed configuration. A front 170 of the box 100 will face consumers at a point of sale. The front 170 of the box 100 includes the window 110 that receives a sample stored-value card to display the stored-value card to the consumer. That is, if the box 100 retains $10 stored-value cards, the window 110 is filled with a sample $10 stored-value card. In one embodiment, the sample card in the window 110 is non-operational. The stored-value cards 102 in the box 100 are removed from an opening 180 in the bottom 182 of the front 170 of the box 100. The security flap 130 arranged on the flanges 120 impedes a consumer from placing a stored-value card 102 back in the box 100 through the opening 180 once the stored-value card 102 has been removed from the box 100. That is, the security flap 130 forms a one-way gate that impedes stored-value cards that have been removed from the card retention device 158 of the box 100 from being repositioned by in the box 100 on the card retention device 158.

FIG. 5 illustrates the hooks 112 attached to the back 172 of the box 100. The hooks 112 are positioned at a top 174 of the back 172 of the box 100 and configured to secure into holes or peg openings 192 in a peg board 190, as shown in FIG. 7, at the point of sale so that the box 100 is retained on the peg board 190. It will be appreciated that the peg board 190 can be formed from any suitable material including, but not limited to, cardboard, particle board, wood, metal (such as steel), plastic, or combinations thereof. The flap 114 extends from the bottom 182 of the box 100. The flap 114 is configured to position against the peg board 190 so that holes 194 in the flap 114 align with holes 192 in the peg board 190. The pegs 116 are inserted into each hole 194 in the flap 114, as shown in FIG. 6, and are configured to expand so that the pegs 116 are secured in the peg board 190, thereby securing the box 100 to the peg board 190, as shown in FIG. 7.

FIGS. 8-30 illustrate various embodiments of a security enhanced peg board display apparatus 300 (hereinafter a “security hook”) for stored-value cards or the like. In the disclosed embodiments, the peg board display apparatus 300 includes a base 301 and or a security component 303. In some embodiments the base 301 and the security component 303 are sold together as a sct that is configured to be attached to a peg board display 190 (as shown in FIG. 7). In some embodiments, the base 301 is pre-existing at a retail location and the security component 303 is attached to the base 301 as an aftermarket component. FIGS. 8-13 illustrate a security component 303 that is configured to be attached to a base 301. FIGS. 14-16 illustrate a base 301 that is configured to operate as a stand-alone component in some embodiments. In other embodiments, a security component 303 can be attached to the bases 301 illustrated in FIGS. 14-16. FIGS. 17-30 illustrate a security component 303 attached to a base 301. The security components 303 include arms 318 having a clip 312. The clip 312 is configured to secure to a base 301, when the security component 303 is attached to the base 301.

The display apparatus 300 includes a body 302 having a back side 304 and an opposite front side 306. The back side 304 and the front side 306 extend between a top 308 and a bottom 310. In the embodiments of FIGS. 14-30, a peg board display component 320 extends from the back side 304 of the body 302 and is configured to be inserted in a peg opening 192 in the peg board display 190 to secure the display apparatus 300 to the peg board display 190 and impede the removal of the display apparatus 300 from the peg board display 190. In an exemplary embodiment, the peg board display component 320 extends from the base 301 of the peg board display apparatus 300. As illustrated in FIG. 14, the peg board display component 320 includes at least one peg board hook 322 that is inserted into the peg opening 192 in the peg board display 190. The at least one peg board hook 322 includes a horizontal component 324 extending from the body 302 and a vertical component 326 extending upward from the horizontal component 324. An end 328 of the vertical component 326 is configured to be inserted through the opening 192 in the peg board display 190. The apparatus 300 is then rotated so that the vertical component 326 is positioned behind the peg board display 190 and the horizontal component 324 extends outwardly behind the peg board display 190. In this position, the body 302 of the apparatus 300 positions against a front of the peg board display 190. In some embodiments, the peg board display component 320, the peg board hook 322, the horizontal component 324, the vertical component 326, or combinations thereof are configured to rotate about an axis. In some embodiments, the peg board display component 320, the peg board hook 322, the horizontal component 324, the vertical component 326, or combinations thereof rotation about an axis causes the peg board display 300 to be secured to the peg board 190. In some embodiments, the peg board display component 320, the peg board hook 322, the horizontal component 324, the vertical component 326, or combinations thereof secure the peg board display 300 to the peg board 190 by rotating after passing through a peg board opening 192 thereby preventing removal of the peg board display 300 from the peg board 190 until the peg board display component 320, the peg board hook 322, the horizontal component 324, the vertical component 326, or combinations thereof are further rotated to allowed for the removal of the peg board display 300 from the peg board 190, e.g., the peg board display component 320, the peg board hook 322, the horizontal component 324, the vertical component 326, or combinations thereof are repositioned to the state they were in just prior to passing through the peg board opening 192. In some embodiments, the peg board hook 322 includes a top peg board hook extending from the top of the body 302 and a bottom peg board hook extending from the bottom of the body 302. In some embodiments, the apparatus 300 does not include peg board display component 320, but rather the apparatus 300 is configured to couple to any surface, such as a wall, a shelf, a rack, or combinations thereof, with a fastening mechanism. In some embodiments, the fastening mechanism includes at least one of a screw, a nail, a bolt, a nut, a washer, a hook, hook and loop fasteners, an adhesive, or combinations thereof.

Referring back to FIGS. 8-30, a card retention device 338 extends from the body 302. In an exemplary embodiment, the card retention device 338 includes an arm 342 extending horizontally from the front side 306 of the body 302 and is configured to retain a plurality of stored-value cards 102. In some embodiments, the peg board display component 320 is unlocked from the peg board display 190 to stock the arm 342 with the plurality of stored-value cards 102. In some embodiments, the arm 342 can be stocked with the plurality of stored-value cards 102 without unlocking the peg board display component 320 from the peg board display 190.

As shown in the embodiment of FIGS. 8-9, the arm 342 operates as a fraud deterrent component 330 including a flange 344 that extends from the arm 342 and operates as a one-way gate 332. The flange 344 includes a vertical component 346 extending upward from the arm 342 and a horizontal component 348 extending outward from the vertical component 346 away from the body 302. The flange 344 impedes the removal of multiple stored-value cards 102 from the arm 342 at one time, while substantially hindering stored-value cards from being positioned back on the arm 342. As shown in the embodiment of FIGS. 10-11, the arm 342 operates as a fraud deterrent component 330 including a flange 350 that operates as a one-way gate 336. The flange 350 extends downward from an end 352 of the arm 342. The flange 350 impedes the removal of multiple stored-value cards from the arm 342 at one time, while substantially hindering stored-value cards from being positioned back on the arm 342.

In the embodiments shown in FIGS. 12-30, a fraud deterrent component 340 comprises a one-way gate 370 that impedes the repositioning of stored-value cards that have been removed from the fraud deterrent component 340 back onto the fraud deterrent component 340. The fraud deterrent component 340 includes an upper arm 372 that extends over the arm 342 so that the arm 342 forms a lower arm. A plurality of stored-value cards 102 are configured to be retained on the arm 342. The one-way gate 370 impedes stored-value cards 102 that have been removed from the arm 342 from being repositioned on the arm 342. In an exemplary embodiment, the upper arm 372 engages the arm 342 to allow a single stored-value card to be removed from the arm 342 at one time. In some embodiments, the peg board display component 320 is unlocked from the peg board display 190 to stock the arm 342 with the plurality of stored-value cards. In some embodiments, the arm 342 can be stocked with the plurality of stored-value cards without unlocking the peg board display component 320 from the peg board display 190. In some embodiments, a tool 375, as shown in FIG. 21, is configured to allow the plurality of stored-value cards to be positioned on the fraud deterrent component 340. In some embodiments the tool 375 can comprise a key, a wrench, fob, a smart device, a computer, an authorization code, or combinations thereof. In some embodiments, a tool 375 is required to service or restock the security hook 300. That is, a retailer utilizes a tool 375 to restock the security hook 300 with additional stored-value cards 102.

In the embodiments of FIGS. 12-30, the fraud deterrent component 340 of the security hook 300 attaches at the top of a peg board display component 320 and cannot be removed by hand from the peg board display component 320 that the fraud deterrent component 340 is engaged with, fitted with, applied to, and/or inserted into. In some embodiments, a fraud deterrent component 340 of the security hook 300 attaches at a bottom of a peg board display component 320 and cannot be removed by hand from the peg board display component 320 that the fraud deterrent component 340 is engaged with, fitted with, applied to, and/or inserted into. In some embodiments, a fraud deterrent component 340 of the security hook 300 attaches at a side of a peg board display component 320 and cannot be removed by hand from the peg board display component 320 that the fraud deterrent component 340 is engaged with, fitted with, applied to, and/or inserted into. In some embodiments, a fraud deterrent component 340 of the security hook 300 attaches at a top and a bottom of a peg board display component 320 and cannot be removed by hand from the peg board display component 320 that the fraud deterrent component 340 is engaged with, fitted with, applied to, and/or inserted into. In some embodiments, a fraud deterrent component 340 of the security hook 300 attaches at a top, a bottom, and a side of a peg board display component 320 and cannot be removed by hand from the peg board display component 320 that the fraud deterrent component 340 is engaged with, fitted with, applied to, and/or inserted into.

In some embodiments, as shown in FIG. 25, a fastening device 314 secures the peg board display apparatus 300 to the peg board display 190. In some embodiments, the fastening device 314 secures the peg board display apparatus 300 to the peg board display 190 via engagement with at least one peg opening 192 while the fastening device 314 is in physical communication with the peg board display apparatus 300. In some embodiments, the fastening device 314 secures the peg board display apparatus 300 to the peg board display 190 via engagement with at least one peg opening 192 while the fastening device 314 is in physical communication with the peg board display apparatus 300 and the engagement of the fastening device 314 with the at least one peg opening 192 comprises a locking mechanism which requires a tool or a key to actuate. In some embodiments, a tool or a key is configured to unlock the peg board display component 320 from the peg board display 190.

In some embodiments, as shown in FIG. 25, a tool 375 is provided to remove the fraud deterrent component 340 from the peg board component 320. In some embodiments, the tool 375 is provided to remove the security hook 300 from the peg board 190. In some embodiments, the tool 375 is provided to remove the security component 303 from the base 301. In some embodiments, the security hook 300 cannot be restocked. e.g., a stored-value card be placed for display on the peg board display component 320, while the fraud deterrent component 340 is engaged with, fitted with, applied to, and/or inserted into the peg board display component 320. In some embodiments, the security hook 300 can be restocked without disengaging the fraud deterrent component 340 from the peg board display component 320, e.g., one stored-value card at a time can be placed for display on the peg board display component 320, while the fraud deterrent component 340 is engaged with, fitted with, applied to, and/or inserted into the peg board display component 320. In some embodiments, the security hook 300 can be restocked without disengaging the fraud deterrent component 340 from the peg board display component 320, e.g., multiple stored-value cards at a time can be placed for display on the peg board display component 320, while the fraud deterrent component 340 is engaged with, fitted with, applied to, and/or inserted into the peg board display component 320.

Referring to the embodiment of FIGS. 12-13, a lower arm 400 includes a flange 402 having a vertical component 404 extending from an end 406 of the lower arm 400. A horizontal component 408 extends outward from the vertical component 404 away from the body 302. An upper arm 410 engages the lower arm 400 to hinder stored-value cards 102 that have been removed from the lower arm 400 from being repositioned on the lower arm 400. The upper arm 410 includes a fraud deterrent mechanism 412 in the form of a tab 413 extending downward from an end 414 of the upper arm 410 to engage the lower arm 400 and impede the stored-value cards 102 that have been removed from the lower arm 400 from being repositioned on the lower arm 400. In some embodiments, the fraud deterrent mechanism 412 engages the lower arm 400 to allow a single stored-value card 102 to be removed from the lower arm 400 at one time.

Referring to the embodiment of FIG. 14, a lower arm 420 includes a flange 422 extending upward from an end 424 of the lower arm 420. An upper arm 430 engages the lower arm 420 to hinder stored-value cards that have been removed from the lower arm 420 from being repositioned on the lower arm 420. The upper arm 430 includes a fraud deterrent mechanism 432 extending downward from an end 434 of the upper arm 430 to engage the lower arm 420 and impede the stored-value cards 102 have been removed from the lower arm 420 from being repositioned on the lower arm 420. The fraud deterrent mechanism 432 includes a flange 436 that is hingedly coupled to the end 434 of the upper arm 430. The flange 436 rotates outward from the end 434 of the upper arm 430 to allow a single stored-value card 102 to be removed from the lower arm 420 at one time. In a retracted position, the flange 436 engages the flange 422 to impede stored-value cards that have been removed from the lower arm 420 from being repositioned on the lower arm 420.

Referring to the embodiments of FIGS. 15 and 16, an upper arm 450 includes a flange 452 extending downward from an end 454 of the upper arm 450. A lower arm 440 engages the upper arm 450 to hinder stored-value cards that have been removed from the lower arm 440 from being repositioned on the lower arm 440. The lower arm 440 includes a fraud deterrent mechanism 442 extending upward from an end 444 of the lower arm 440 to engage the upper arm 450 and impede the stored-value cards that have been removed from the lower arm 440 from being repositioned on the lower arm 440. The fraud deterrent mechanism 442 includes a flange 446 that is hingedly coupled to the end 444 of the lower arm 440. The flange 446 rotates outward from the end 444 of the lower arm 440 to allow a single stored-value card to be removed from the lower arm 440 at one time. In a retracted position, the flange 446 engages the flange 452 to impede stored-value cards that have been removed from the lower arm 440 from being repositioned on the lower arm 440. In the embodiment of FIG. 16 the flange 452 is rounded to form a concave notch 456 that receives the flange 446.

Referring to the embodiments of FIGS. 17 and 18, a lower arm 460 includes a flange 462 extending upward from an end 464 of the lower arm 460. The lower arm 460 also includes a plurality of ridges 466 along an upper surface 468 of the lower arm 460. In some embodiments, the ridges 466 hinder movement of each stored-value card along the lower arm 460 to impede the removal of multiple stored-value cards from the lower arm 460 at one time. An upper arm 470 includes a flange 472 that engages the flange 462 of the lower arm 460 to impede stored-value cards that have been removed from the lower arm 460 from being repositioned on the lower arm 460. The flange 472 of the upper arm 470 includes a fraud deterrent mechanism 474 in the form of at least one tooth 475 angled downward from the flange 472 and configured to engage an outer surface 476 of the flange 462 of the lower arm 460 to impede the stored-value cards that have been removed from the lower arm 460 from being repositioned on the lower arm 460. In some embodiments, the fraud deterrent mechanism 474 engages the outer surface 476 of the flange 462 of the lower arm 460 to allow a single stored-value card to be removed from the lower arm 460 at one time.

Referring to the embodiments of FIGS. 19-20, a lower arm 480 includes a flange 482 extending upward from an end 484 of the lower arm 480. The lower arm 480 also includes a plurality of ridges 486 along an upper surface 488 of the lower arm 480. In some embodiments, the ridges 486 hinder movement of each stored-value card along the lower arm 480 to impede the removal of multiple stored-value cards from the lower arm 480 at one time. An upper arm 490 includes a flange 492 that engages the flange 482 of the lower arm 480 to impede stored-value cards that have been removed from the lower arm 480 from being repositioned on the lower arm 480. The flange 492 of the upper arm 490 includes a fraud deterrent mechanism 494 in the form of a tab 495 that is configured to engage an inner surface 496 of the flange 482 of the lower arm 480 to hinder the stored-value cards that have been removed from the lower arm 480 from being repositioned on the lower arm 480. In some embodiments, the fraud deterrent mechanism 494 engages inner surface 496 of the flange 482 of the lower arm 480 to allow a single stored-value card to be removed from the lower arm 480 at one time.

Referring to the embodiments of FIGS. 21-25, a lower arm 500 includes an outer arm 502 having flange 504 that includes a vertical component 506 extending upward from an end 508 of the arm 502. A horizontal component 510 extends outward from the vertical component 506 away from the body 302. A slot 512 is formed at least partially along a length of the arm 502 and the vertical component 506. An inner arm 514 extends through the slot 512. The inner arm 514 includes a flange 516 extending at least partially along a length of the vertical component 506. An upper arm 530 includes a fraud deterrent mechanism 532 in the form of a tab 535 that is configured to engage the horizontal component 510 of the flange 504 of the lower arm 500 to impede the stored-value cards that have been removed from the lower arm 500 from being repositioned on the lower arm 500. In some embodiments, the fraud deterrent mechanism 532 engages horizontal component 510 of the flange 504 of the lower arm 500 to allow a single stored-value card to be removed from the lower arm 500 at one time. As seen in the embodiments of FIGS. 24-25, the fraud deterrent mechanism 532 is cantilevered at an end 534 of the upper arm 530 to allow movement of the fraud deterrent mechanism 532 to remove a stored-value card from the lower arm 500.

Referring to the embodiment of FIGS. 26-27, the security hook 300 includes a swing arm 540 that is unlocked and rotated to allow access for restocking a lower arm 550 of the security hook 300. The swing arm 540 is attached to the body 302 at a pivot 542. The swing arm 540 is configured to rotate about the pivot 542 along the path of arrow 544 between a closed position and an open position. In some embodiments, a tool 375 is configured to unlock and move the swing arm 540. That is, the swing arm 540 locks in the closed position to secure a plurality of stored-value cards on the lower arm 550. The tool 375 unlocks the swing arm 540 so that the swing arm 540 rotates about the pivot 542 to enable the stored-value cards to be stored on the lower arm 550.

Referring to the embodiments of FIGS. 28-34, a security hook 590 includes an upper portion 615 and a lower portion 605 comprising a lower arm 600 and an upper arm 610. The lower arm 600 comprises a flange 602 extending upward from an end 604 of the lower arm 600. Upper arm 610 is configured to couple with a fraud deterrent mechanism 612. The upper arm 610 comprises a stationary member 614 which is configured to engage and cooperate with the fraud deterrent mechanism's sliding member 616. As shown in FIG. 30, the stationary member 614 includes a track 618 that the sliding member 616 is configured to move along between a closed position 620 (shown in FIG. 28) and an open position 622 (shown in FIG. 29). A pin 625 (shown in FIG. 32) extends laterally through the sliding member 616 to maintain a relative position of the sliding member 616 and the stationary member 614 as the sliding member 616 moves longitudinally along the stationary member 614.

The sliding member 616 is unlocked and allowed to move using the tool 630 (shown in FIG. 31). The tool 630 includes teeth 632 that engage the sliding member 616 to unlock the sliding member 616 and allow the sliding member 616 to move relative to the stationary member 614. As shown in FIGS. 32-34, the teeth 632 of tool 630 engage sliding member 616 by contacting lock plate 660 at fins 661a and 661b (shown in FIG. 33) by passing through lock cover 665 at lock cover openings 668a and 668b (shown in FIG. 34). Teeth 632 of tool 630 cause lock plate 660 to disengage from upper arm 610 in its locked closed position 620 and allows sliding member 616 to move along upper arm 610 to result in the fraud deterrent mechanism 612 be placed in open position 622 thereby allowing multiple cards to be positioned on the lower arm 600. In an embodiment, disengagement of lock plate 660 from upper arm 610 is effectuated by notch 664 of lock plate 660 being prevented from contacting restricting component 611.

The lock cover 665 is secured to the sliding member 612 with fasteners 675 so that the lock plate 660 is held in place between the lock cover 665 and the sliding member 612 and allowed to move between the lock cover 665 and the sliding member 612. A fraud deterrent tab 635 is secured between the lock cover 665 and the sliding member 612 so that an end 637 of the fraud deterrent tab 635 extends downward through an opening 639 in the lock cover 665 and moves relative to the lock cover 665 on springs 670. The end 637 of the fraud deterrent tab 635 includes an angled side facing the lower portion 605 that allows cards to be removed from the lower arm 600 by pushing the fraud deterrent tab 635 upward on the springs 670. In a closed position, a flat face of the fraud deterrent tab 635 prevents movement of the fraud deterrent tab 635 to prevent cards from being repositioned on the lower arm 600.

In the closed position 620, the fraud deterrent mechanism 612 impedes stored-value cards that have been removed from the lower arm 600 from being repositioned on the lower arm 600. In some embodiments, the fraud deterrent mechanism 612 allows a single stored-value card to be removed from the lower arm 600 at one time. In the open position 622, an opening 650 between the flange 602 and the sliding member 616 enables stored-value cards to be repositioned on the lower arm 600. In some embodiments, the opening 650 enables multiple stored-value cards to be repositioned on the lower arm 600 at one time. The security hook 590 (e.g., the fraud deterrent mechanism 612 and the lower portion 605) includes at least one upper peg board display component 640 and at least one lower peg board display component 642 configured to attach to the peg board display 190 so that when the lower portion 605 (when attached to the peg board display 190) and the fraud deterrent mechanism 612 (when attached to the peg board display 190) are coupled together to form the security hook 590, the security hook 590 is secured and/or locked to the peg board display 190 via engagement of the upper peg board display component 640 and the lower peg board display component 642 with the peg board display 190 via insertion of the upper peg board display component 640 and the lower peg board display component 642 through peg openings 192.

In some embodiments, the security hooks illustrated herein impede the removal of multiple stored-value cards at one time. In some embodiments, the security hooks illustrated herein provide a one-way system that allows the removal of a single card at a time, while substantially hindering stored-value cards from being positioned back on the peg board display component.

The following paragraphs enumerated consecutively from 1 through 46 provide various embodiments of the present invention:

1. A security enhanced peg board display apparatus comprising:
a body configured to position against a peg board display, the body having a back side and an opposite front side, the back side and the front side extending between a top and a bottom,
a peg board display component extending from the back side of the body and configured to attach to the peg board display so that the display apparatus is locked to the peg board display,
a card retention device included on the body and configured to retain a plurality of stored-value cards, and
a one-way gate that impedes stored-value cards that have been removed from the card retention device from being repositioned on the card retention device.

2. The display apparatus of clause 1, wherein the one-way gate prevents stored-value cards that have been removed from the card retention device from being repositioned on the card retention device.

3. The display apparatus of clause 1, wherein the card retention device allows a single stored-value card to be removed from the card retention device at one time.

4. The display apparatus of clause 1, wherein the card retention device includes a fraud deterrent mechanism that impedes the stored-value cards that have been removed from the card retention device from being repositioned on the card retention device.

5. The display apparatus of clause 1, further comprising a tool that is configured to unlock the peg board display component from the peg board display.

6. The display apparatus of clause 5, wherein the peg board display component is unlocked from the peg board display to stock the card retention device with the plurality of stored-value cards.

7. The display apparatus of clause 1, wherein the card retention device can be stocked with the plurality of stored-value cards without unlocking the peg board display component from the peg board display.

8. The display apparatus of clause 1, further comprising a tool that is configured to allow access the card retention device to position the plurality of stored-value cards on the card retention device.

9. The display apparatus of clause 1, wherein the peg board display component includes a top peg board display component extending from the top of the body and a bottom peg board display component extending from the bottom of the body.

10. A security enhanced peg board display apparatus comprising:
a body configured to position against a peg board display, the body having a back side and an opposite front side, the back side and the front side extending between a top and a bottom,
at least one peg board hook extending from the back side of the body and configured to be inserted in a hole in the peg board display so that the display apparatus cannot be removed from the peg board display by hand,
a fraud deterrent component extending from the front side of the body and configured to retain a plurality of stored-value cards, wherein the fraud deterrent component comprises a one-way gate having an upper arm and a lower arm, wherein the plurality of stored-value cards are retained on the lower arm, wherein at least one of the upper arm and the lower arm incudes a flange that impedes stored-value cards that have been removed from the lower arm from being repositioned on the lower arm.

11. The display apparatus of clause 10, wherein the flange prevents stored-value cards that have been removed from the lower arm from being repositioned on the lower arm.

12. The display apparatus of clause 10, wherein the flange allows a single stored-value card to be removed from the lower arm at one time.

13. The display apparatus of clause 10, wherein the flange includes a fraud deterrent mechanism that impedes the stored-value cards that have been removed from the lower arm from being repositioned on the lower arm.

14. The display apparatus of clause 10, further comprising a tool that is configured to remove the peg board hook from the peg board display.

15. The display apparatus of clause 14, wherein the peg board hook is unlocked from the peg board display to stock the lower arm with the plurality of stored-value cards.

16. The display apparatus of clause 10, wherein the lower arm can be stocked with the plurality of stored-value cards without unlocking the peg board hook from the peg board display.

17. The display apparatus of clause 10, wherein the upper arm is movable to access the lower arm and position the plurality of stored-value cards on the lower arm.

18. The display apparatus of clause 17, further comprising a tool that is configured to move the upper arm.

19. The display apparatus of clause 10, wherein the peg board hook includes a top peg board hook extending from the top of the body and a bottom peg board hook extending from the bottom of the body.

20. A security enhanced peg board display apparatus comprising
a body configured to position against a peg board display and retain a plurality of stored-value cards,
a peg board display component extending from the body and configured to attach to the peg board display so that the display apparatus is locked to the peg board display, and
a fraud deterrent component extending from the body and configured to impede stored-value cards that have been removed from the body from being repositioned on the body.

21. The display apparatus of clause 20, wherein the fraud deterrent component prevents stored-value cards that have been removed from the body from being repositioned on the body.

22. The display apparatus of clause 20, further comprising a tool configured to allow the plurality of stored-value cards to be positioned on the body.

23. The display apparatus of clause 20, wherein the fraud deterrent component allows a single stored-value card to be removed from the body at one time.

24. A security enhanced display apparatus comprising:
a body configured to position against a display, the body having a back side and an opposite front side, the back side and the front side extending between a top and a bottom,
a display component extending from the back side of the body and configured to attach to the display so that the display apparatus is locked to the display,
a card retention device included on the body and configured to retain a plurality of stored-value cards, and
a one-way gate that impedes stored-value cards that have been removed from the card retention device from being repositioned on the card retention device.

25. The display apparatus of clause 24, wherein the one-way gate prevents stored-value cards that have been removed from the card retention device from being repositioned on the card retention device.

26. The display apparatus of clause 24, wherein the card retention device allows a single stored-value card to be removed from the card retention device at one time.

27. The display apparatus of clause 24, wherein the card retention device includes a fraud deterrent mechanism that impedes the stored-value cards that have been removed from the card retention device from being repositioned on the card retention device.

28. The display apparatus of clause 24, further comprising a tool that is configured to unlock the display component from the display.

29. The display apparatus of clause 28, wherein the display component is unlocked from the display to stock the card retention device with the plurality of stored-value cards.

30. The display apparatus of clause 24, wherein the card retention device can be stocked with the plurality of stored-value cards without unlocking the display component from the display.

31. The display apparatus of clause 24, further comprising a tool that is configured to allow access the card retention device to position the plurality of stored-value cards on the card retention device.

32. The display apparatus of clause 24, wherein the display component includes a top display component extending from the top of the body and a bottom display component extending from the bottom of the body.

33. A security enhanced display apparatus comprising:
a body configured to position against a display, the body having a back side and an opposite front side, the back side and the front side extending between a top and a bottom,
at least one fastener extending from the back side of the body and configured to be coupled to the display so that the display apparatus cannot be removed from the display by hand,
a fraud deterrent component extending from the front side of the body and configured to retain a plurality of stored-value cards, wherein the fraud deterrent component comprises a one-way gate having an upper arm and a lower arm, wherein the plurality of stored-value cards are retained on the lower arm, wherein at least one of the upper arm and the lower arm incudes a flange that impedes stored-value cards that have been removed from the lower arm from being repositioned on the lower arm.

34. The display apparatus of clause 33, wherein the flange prevents stored-value cards that have been removed from the lower arm from being repositioned on the lower arm.

35. The display apparatus of clause 33, wherein the flange allows a single stored-value card to be removed from the lower arm at one time.

36. The display apparatus of clause 33, wherein the flange includes a fraud deterrent mechanism that impedes the stored-value cards that have been removed from the lower arm from being repositioned on the lower arm.

37. The display apparatus of clause 33, further comprising a tool that is configured to remove the fastener from the display.

38. The display apparatus of clause 37, wherein the fastener is unlocked from the display to stock the lower arm with the plurality of stored-value cards.

39. The display apparatus of clause 33, wherein the lower arm can be stocked with the plurality of stored-value cards without unlocking the fastener from the display.

40. The display apparatus of clause 33, wherein the upper arm is movable to access the lower arm and position the plurality of stored-value cards on the lower arm.

41. The display apparatus of clause 40, further comprising a tool that is configured to move the upper arm.

42. The display apparatus of clause 33, wherein the fastener includes a top fastener extending from the top of the body and a bottom fastener extending from the bottom of the body.

43. A security enhanced display apparatus comprising:
a body configured to position against a display and retain a plurality of stored-value cards,
a display component extending from the body and configured to attach to the display so that the display apparatus is locked to the display, and
a fraud deterrent component extending from the body and configured to impede stored-value cards that have been removed from the body from being repositioned on the body.

44. The display apparatus of clause 43, wherein the fraud deterrent component prevents stored-value cards that have been removed from the body from being repositioned on the body.

45. The display apparatus of clause 43, further comprising a tool configured to allow the plurality of stored-value cards to be positioned on the body.

46. The display apparatus of clause 43, wherein the fraud deterrent component allows a single stored-value card to be removed from the body at one time.

Any theory, mechanism of operation, proof, or finding stated herein is meant to further enhance understanding of principles of the present disclosure and is not intended to make the present disclosure in any way dependent upon such theory, mechanism of operation, illustrative embodiment, proof, or finding. It should be understood that while the use of the word preferable, preferably or preferred in the description above indicates that the feature so described can be more desirable, it nonetheless cannot be necessary and embodiments lacking the same can be contemplated as within the scope of the disclosure, that scope being defined by the claims that follow.

When terms of degree such as “generally,” “substantially,” and “about” are used herein in connection with a numerical value or a qualitative term susceptible to a numerical measurement, it is contemplated that an amount that is plus or minus 10 percent, and possibly up to plus or minus 20 percent, of the numerical value, is covered by such language, unless specifically noted otherwise, to at least account for manufacturing tolerances. Otherwise, a suitable definition for “generally,” “substantially,” and “about” is largely, but not necessarily wholly, the term specified.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used, the item can include a portion and/or the entire item unless specifically stated to the contrary.

It should be understood that only selected embodiments have been shown and described and that all possible alternatives, modifications, aspects, combinations, principles, variations, and equivalents that come within the spirit of the disclosure as defined herein or by any of the following claims are desired to be protected. While embodiments of the disclosure have been illustrated and described in detail in the drawings and foregoing description, the same are to be considered as illustrative and not intended to be exhaustive or to limit the disclosure to the precise forms disclosed. Additional alternatives, modifications and variations can be apparent to those skilled in the art. Also, while multiple inventive aspects and principles have been presented, they need not be utilized in combination, and many combinations of aspects and principles are possible in light of the various embodiments provided above.

What is claimed is:

1. A security enhanced peg board display system comprising:
a body configured to position against a peg board display, the body having a back side and an opposite front side, the back side and the front side extending between a top and a bottom,
a peg board display component extending from the back side of the body and configured to attach to the peg board display so that the display apparatus is locked to the peg board display,
a card retention device included on the body and configured to retain a plurality of stored-value cards, and
a one-way gate that impedes stored-value cards that have been removed from the card retention device from being repositioned on the card retention device.

2. The display system of claim 1, wherein the one-way gate prevents stored-value cards that have been removed from the card retention device from being repositioned on the card retention device.

3. The display system of claim 1, wherein the card retention device allows a single stored-value card to be removed from the card retention device at one time.

4. The display system of claim 1, wherein the card retention device includes a fraud deterrent mechanism that impedes the stored-value cards that have been removed from the card retention device from being repositioned on the card retention device.

5. The display system of claim 1, further comprising a tool that is configured to unlock the peg board display component from the peg board display.

6. The display system of claim 5, wherein the peg board display component is unlocked from the peg board display to stock the card retention device with the plurality of stored-value cards.

7. The display system of claim 1, wherein the card retention device can be stocked with the plurality of stored-value cards without unlocking the peg board display component from the peg board display.

8. The display system of claim 1, further comprising a tool that is configured to allow access the card retention device to position the plurality of stored-value cards on the card retention device.

9. The display system of claim 4, wherein the tool is configured to engage a lock plate through the fraud deterrent mechanism to allow the fraud deterrent mechanism to slide into an open position for adding the plurality of stored-value cards to the card retention device.

10. A security enhanced peg board display apparatus comprising:
a body configured to position against a peg board display, the body having a back side and an opposite front side, the back side and the front side extending between a top and a bottom,
at least one peg board hook extending from the back side of the body and configured to be inserted in a hole in the peg board display so that the display apparatus cannot be removed from the peg board display by hand,
a fraud deterrent component extending from the front side of the body and configured to retain a plurality of stored-value cards, wherein the fraud deterrent component comprises a one-way gate having an upper arm and a lower arm, wherein the plurality of stored-value cards are retained on the lower arm, wherein at least one of the upper arm and the lower arm incudes a flange that impedes stored-value cards that have been removed from the lower arm from being repositioned on the lower arm.

11. The display apparatus of claim 10, wherein the flange prevents stored-value cards that have been removed from the lower arm from being repositioned on the lower arm.

12. The display apparatus of claim 10, wherein the flange allows a single stored-value card to be removed from the lower arm at one time.

13. The display apparatus of claim 10, wherein the flange includes a fraud deterrent mechanism that impedes the stored-value cards that have been removed from the lower arm from being repositioned on the lower arm.

14. The display apparatus of claim 10, further comprising a tool that is configured to remove the peg board hook from the peg board display.

15. The display apparatus of claim 14, wherein the peg board hook is unlocked from the peg board display to stock the lower arm with the plurality of stored-value cards.

16. The display apparatus of claim 10, wherein the lower arm can be stocked with the plurality of stored-value cards without unlocking the peg board hook from the peg board display.

17. The display apparatus of claim 10, wherein the upper arm is movable to access the lower arm and position the plurality of stored-value cards on the lower arm.

18. The display apparatus of claim 17, further comprising a tool that is configured to move the upper arm.

19. The display apparatus of claim 10, wherein the peg board hook includes a top peg board hook extending from the top of the body and a bottom peg board hook extending from the bottom of the body.

20. A security enhanced peg board display apparatus comprising:
a body configured to position against a peg board display and retain a plurality of stored-value cards,
a peg board display component extending from the body and configured to attach to the peg board display so that the display apparatus is locked to the peg board display, and
a fraud deterrent component extending from the body and configured to impede stored-value cards that have been removed from the body from being repositioned on the body.
